(19) United States
(12) Patent Application Publication
(10) Pub. No.: US 2010/0199203 A1
(43) Pub. Date: Aug. 5, 2010

(54) Apparatus for Displaying and Managing System Parameters and Data Pertaining to a Dental Treatment Station

(75) Inventors: Tobias Bauer, Ulm (DE); Ralph Munzer, Friedrichshafen (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Kaltenbach & Voigt GmbH, Biberach (DE)

(21) Appl. No.: 12/523,841

(22) PCT Filed: Jan. 21, 2008
(86) PCT No.: PCT/EP08/00425

§ 371 Date: Dec. 23, 2009

(30) Foreign Application Priority Data
Jan. 24, 2007 (DE) 10 2007 003 471.9

(51) Int. Cl. G06F 15/16; A61G 15/10; G06F 17/30; G06F 3/048

(52) U.S. Cl. 715/771; 433/101; 707/769; 709/217; 707/E17.014

(57) ABSTRACT

For an apparatus for displaying and managing system parameters and data from a dental treatment station having connecting means for connecting the apparatus to a display for displaying the system parameters or data and having communication means for data interchange with the dental treatment station, provision is made for the communication means to check data relating to the current operating state of the treatment station at regular intervals.

The present invention relates to an apparatus for displaying and managing system parameters and data pertaining to a dental treatment station, according to the precharacterising portion of claim 1.

Dental treatment stations exhibit a large number of instruments and devices which are used by the dentist or by a dental assistant within the scope of a treatment. The appropriate instruments serve in this connection not only for therapeutic treatment of the patient but also for diagnostic purposes, in order, for example, to detect caries in good time by means of suitable optical processes. In particular, the linking of diagnostic instruments of such a type with so-called intraoral cameras enables the dentist to explain to the patient particularly vividly—through the representation of appropriate images on a display—the result of the examination and the therapeutic measures required in the given case. Accordingly it is endeavored to undertake a control of the various instruments and also an acquisition of the information obtained by them in uniform manner.

The recently increasing digitization of the dental surgery in this context has had the result that the most diverse software applications have to be run by the dentist within the scope of an examination/treatment. In this connection in particular the linking of this application software to customary surgery-management programs is also desired, in order to be able to undertake a centralized management of the data.

Efforts are accordingly being made to make available centralized, application-spanning applications software that enables the dentist to support the entire treatment sequence. In addition to the servicing of immediately therapeutic functional areas, in this connection the provision of information to the patient and attendant measures prepared using multimedia are—as already mentioned above—also to the fore with the aim of making the treatment procedure itself as agreeable as possible both for the patient and for the therapist.

In this context several solutions have already been proposed in order to assist the working sequence at a dental treatment station within the scope of multimedia applications.

For example, WO 2004/080324 A1 describes an information and control system for use at a dental treatment station, which on a display assigned to the treatment station provides information concerning the working steps to be carried out. In this case a dentist can select a desired treatment from a number of different treatments, the individual working steps—as well as the tools and accessories needed for them—then being displayed within the scope of a sequence listing. In this way it is intended to be ensured within the scope of an inspection that the treatment is carried out in accordance with the current standards.

WO 2005/070366 A1 again describes a system for operating a dental treatment station, which is designed with the aim of carrying out almost all the settings and control operations of the treatment station with the aid of a single control element. With this control element it is a question of a foot-switch which is provided on the treatment station. Depending on which instrument is to be driven at the time, the functionality of the individual push-buttons of the foot-switch changes, the control options that are currently available being represented on a display.

Lastly, WO 2006/037862 A1 describes an arrangement consisting of a dental treatment station and a PC assigned to said station, wherein a common input device is provided for the purpose of controlling the dental treatment station as well as the PC. In this connection, in particular the use of a touch screen is proposed, which, on the one hand, is used for activating and controlling individual functions of the treatment station and, on the other hand, also serves to use applications programs running on the PC within the scope of a graphical user interface.

The present invention relates to an apparatus that is comparable to the solutions previously described, the task of which is to display and manage the system parameters of a dental treatment station and the data resulting within the scope of dental examinations. In this connection the object underlying the present invention is, in particular, to optimize the linking of this apparatus to the dental treatment station in such a manner that, on the one hand, the work of the dentist or of a dental assistant is assisted in the best possible way and, on the other hand, the information displayed by the apparatus at any time enables an inference as to the current state of the treatment station and the available options.

The object is achieved by an apparatus for displaying and managing system parameters and data pertaining to a dental treatment station, according to claim 1. Advantageous further developments of the invention are the subject-matter of the dependent claims.

The solution according to the invention is based on the fundamental idea of optimizing the communication between the apparatus for displaying and managing the system parameters and data and the dental treatment station in such a manner that the apparatus according to the invention is informed in detailed manner at any time about the state of the treatment station. There is accordingly provision that the apparatus according to the invention preferentially queries data concerning the current operating state of the treatment station at regular intervals via a serial interface. For this purpose an information packet is communicated to a control device of the dental treatment station, which is likewise answered by the treatment station within the scope of a packet, this response packet containing all the state information.

In accordance with the invention, an apparatus for displaying and managing system parameters and data pertaining to a dental treatment station is accordingly proposed, said apparatus exhibiting connection means for connecting the apparatus to a display that is utilized for displaying the system parameters and data, as well as communication means for data exchange with the dental treatment station, whereby in accordance with the invention there is provision that the communication means query data concerning the current operating state of the treatment station at regular time-intervals.

By virtue of the measure according to the invention it is ensured that a user of the dental treatment station is informed of the current operating state at any time by visual means. Treatment sequences and the use of individual instruments of the treatment station can be optimized in this way.

There is preferentially provision that the operation and drive of the various instruments of the dental treatment station and also of a graphical user interface provided by the apparatus can be effected substantially by a central input device, whereby in this connection in particular the use of the foot-switch which is available at the dental treatment station is provided. The foot-switch accordingly serves in this case as main input device both for the treatment station and for the apparatus, whereby with the aid of the various push-buttons of the foot-switch the user is enabled, on the one hand, to operate the individual treatment instruments and diagnostic instruments and, on the other hand, to navigate by means of the graphical user interface, in order to select and activate individual functions and menu items. A supplementary connection of the apparatus to a further input element—for example, a keypad and/or a mouse—may, of course, likewise be provided, but at least the operation and selection of the essential functions is already made possible with the aid of the foot-switch. The available functions and selection options, depending on the selected treatment instrument or diagnostic instrument, which can be activated with the aid of the push-buttons of the foot-switch, are in this case preferentially output on the display within the scope of an information bar. Other current parameters of the treatment station—such as, for example, the speed of rotation of the instrument, as well as simple status information and active error conditions—can be displayed on the display.

Input information that is generated with the aid of the foot-switch or generally with the aid of the central control element is preferentially communicated autonomously from the dental treatment station to the apparatus according to the invention. Should special function keys be provided at the dental treatment station for the purpose of activating certain functions, the latter can, in certain situations, be equated with the push-buttons of the foot-switch. Upon actuation of one of these push-buttons, the same signal is accordingly communicated to the apparatus according to the invention that would also have been triggered by a corresponding actuation of the associated push-button of the foot-switch.

In addition to control and management of the system parameters of the dental treatment station, a further function of the apparatus according to the invention consists—as already mentioned—in collecting and managing additional diagnostic information within the scope of an examination of an patient. In this context there may be provision that the apparatus exhibits additional terminals for connecting to diagnostic instruments or to image-recording units, for example to a camera or such like. The information and data obtained with the aid of instruments of such a type are accordingly communicated directly to the apparatus according to the invention and can then be represented on the assigned display. Furthermore, there may be provision that these diagnostic data are stored in patient-specific manner, for which purpose the apparatus is preferentially capable of being connected to a communications network, for example a surgery network, in order to be able to access the patient database that is customarily used in dental surgeries. This communication with the communications network may include, in particular, both the transmission of acquired system parameters and data from the apparatus and the transmission of patient information and data to the apparatus.

Finally, an apparatus is accordingly made available, by means of which the daily work of the dentist is clearly facilitated, since by virtue of a graphical representation of the differing information on the one hand the operation of the various instruments of the treatment station is supported and on the other hand the management of the information obtained by this means is facilitated.

The invention will be elucidated in more detail in the following on the basis of the accompanying drawing. Shown are:

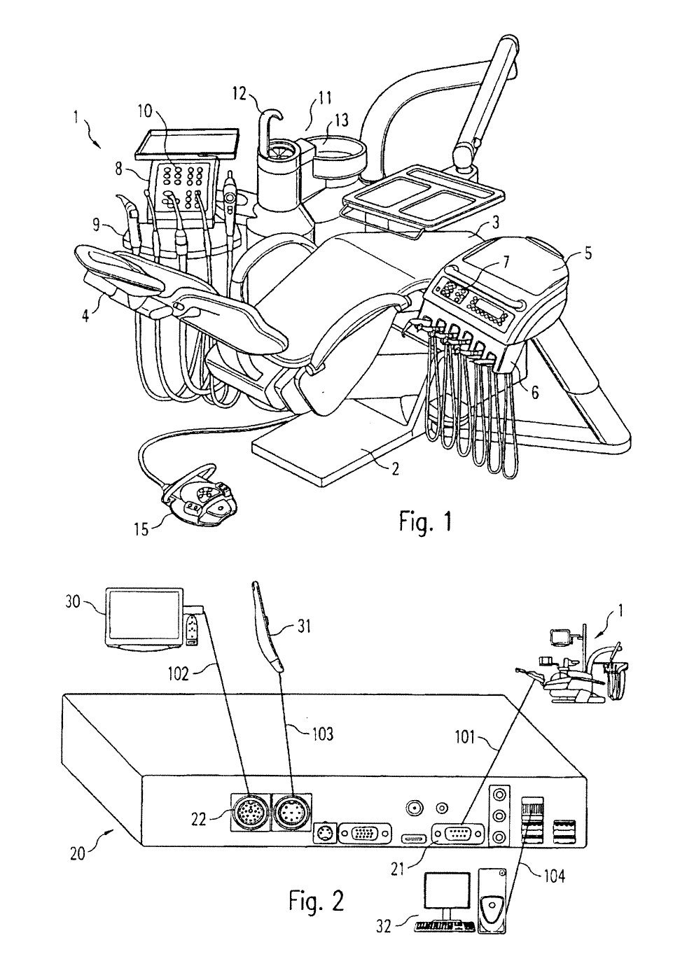

FIG. 1 the general configuration of a dental treatment station;

FIG. 2 an exemplary embodiment of an apparatus according to the invention and also the connection options of the apparatus; and

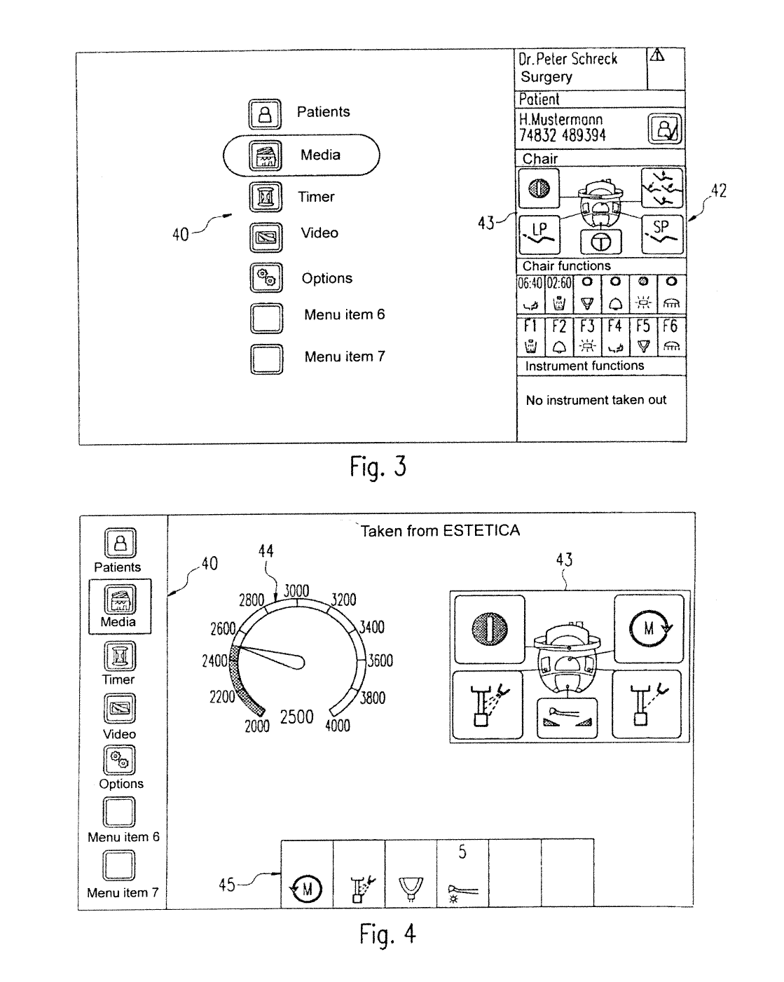

FIGS. 3 to 5 examples of the representation of system parameters and data on a display within the scope of a graphical user interface made available by the apparatus according to the invention.

On the basis of FIG. 1 the different input options and control functions that are available at a dental treatment station will firstly be elucidated. The central element of the dental treatment station provided generally with reference numeral 1 in FIG. 1 is a treatment chair 2 with a height-adjustable bench-seat 3 and also with a back-rest 4 which is tiltably arranged at the rear end of the bench-seat 3.

In the example that is represented, the patient chair 2 also serves as a central console on which various different utensils of the treatment station 1 are mounted. In this connection, firstly the table that is primarily used by the treating physician, the so-called service table 5, is to be mentioned, on which the instrument storage compartment 6 is located. In this instrument storage compartment 6 different treatment instruments and examination instruments—for example, dental drilling handpieces, scalers etc.—are stored which, depending on the type of the treatment or examination to be carried out, are employed by the dentist and are supplied with appropriate media such as current, air and/or water by the treatment station 1. In this connection, certain operating parameters of the instrument currently being used can be adjusted, for example via a keypad 7 arranged on the service table 5.

An element comparable to the service table is also arranged on the opposite side of the patient chair 2. In this case it is a question of the so-called assistant element 8 which likewise exhibits an instrument storage compartment 9 for holding certain instruments which are employed by the assistant for the purpose of assisting the treatment being undertaken by the dentist. Also in this case an activation or adjustment of certain operating parameters of these instruments can be effected by means of a keypad 10 on the assistant element 8.

Finally, a so-called patient part 11 with a water supply 12 and with a spit basin 13 is also provided, via which water for rinsing the oral cavity can be made available to the patient.

These various utensils of the dental treatment station 1 can—as already mentioned—be operated at least partly by means of the keypads 7 and 10. The treatment station additionally exhibits by way of central operating element a foot-switch 15. The latter is primarily used by the dentist for the purpose of driving the treatment instrument currently being used, in order, for example, to enable an activation of a drill or an adjustment of the speed of rotation without the actuation of certain keys of the keypad 7. By this means, for the dentist the possibility is opened up of concentrating primarily on the handling of the instrument during a treatment.

Further instruments that often find application at a dental treatment station and that are not represented in FIG. 1 are, in particular, diagnostic instruments for the visual diagnosing of caries or for creating images from the oral cavity of the patient. Instruments of such a type—so-called intraoral cameras or, for example, the visual caries-diagnosis system DIAGNOdent marketed by the applicant—either constitute instruments that are independent of the treatment station 1 or are customarily directly connected to a PC in order to make the image information obtained by this means available on a display.

From the above description of the various instruments which are present at a dental treatment station it can be gathered that for the treating dentist numerous options and functions are available which can be selected, depending on the type of the treatment to be carried out. Furthermore, in order to be able to carry out a treatment in optimal manner the most diverse instruments must be activated or must have their operating parameters adjusted. Accordingly, in order to simplify the operation of a treatment station of such a type overall, in accordance with the invention an apparatus for displaying and managing system parameters and data pertaining to a treatment station is proposed which will be elucidated in the following. In this connection FIG. 2 firstly shows the integration of the apparatus according to the invention into a dental surgery.

In the case of the apparatus according to the invention, which is provided generally with reference numeral 20, it is a question of a PC-based system which is preferentially integrated into the dental treatment station 1 itself, though as an alternative to this it could also be arranged at another location as a separate unit. FIG. 2 accordingly illustrates primarily the data-processing connection of the apparatus 20 to the various components and devices of a dental surgery.

As can be gathered from the representation, the apparatus 20 is firstly connected to the dental treatment station 1, preferentially via a serial data connection 101 with the aid of appropriately designed communication means 21. A further essential connection 102 is constituted by that to a display 30 for representing the various operating parameters and data. As will be elucidated later in more detail, in this case the data and information are represented on the display 30—which, for example, may be arranged on the treatment station 1 itself—within the scope of a graphical user interface. The apparatus 20 according to the invention furthermore opens up the possibility of connecting imaging instruments such as, for example, an intraoral camera 31 via a further connection 103. Finally, connection to a surgery network, represented symbolically by a further PC 32, is also possible via a fourth connection 104. The connection to the surgery network may be utilized, for example, both for transmitting acquired system parameters and data from the apparatus 20 to the surgery network and for transmitting patient information and data to the apparatus 20. Communication with these various devices is effected in this case via customary interfaces or data connections such as, for example, USB, wireless USB, Bluetooth, Ethernet etc.

The primary task of the apparatus 20 according to the invention is firstly to represent the various control options of the dental treatment station 1 in vivid manner on the display 30 and accordingly to simplify the operation for a dentist. For this purpose a regular data exchange between the apparatus 20 and the treatment station 1 is required, whereby, in particular, there is provision that the apparatus 20 queries system parameters of the treatment station 1 for the purpose of regular equalization of the operating information. This is effected by information relating to the detailed state of the treatment station 1 being regularly requested via the serial data connection 101, for which purpose an information packet is communicated to the control unit of the treatment station 1, which said control unit in turn answers with a packet that contains all the state information. By this special type of data communication it is ensured that the apparatus 20 is informed at any time of the current operating state of the treatment station 1 and can accordingly display the corresponding information on the display 30 in correct manner.

A further type of communication between the treatment station 1 and the apparatus 20 is required when options represented on the display 30 have to be selected or navigation is to be effected by means of the graphical user interface represented on the display 30. In this case there is provision, in particular, that, apart from the additional possibility for data input with the aid of an additional keypad and/or mouse, a navigation is effected with the aid of the foot-switch 15 provided at the treatment station 1. Accordingly, if upon an actuation of the foot-switch 15 control signals are generated that are relevant for the purpose of navigating in the graphical user interface, these are communicated autonomously from the dental treatment station 1 to the apparatus. On the other hand, control signals generated by the foot-switch 15 that relate to the drive of a certain component of the treatment station—for example, the adjustment of the patient chair 2 or the drive of a treatment instrument that has been removed from the instrument storage compartment 6—are communicated directly from the control unit of the treatment station to the corresponding component. The foot-switch 15 can be utilized in this way as a general operating element for the treatment station 1 and for the apparatus 20.

The foot-switch 15 serves accordingly as main input device not only for the treatment station 1 but also for the apparatus 20. If the foot-switch 15 is used for controlling a component of the dental treatment station 1, the assignment of the various push-buttons of the foot-switch 15 inevitably changes, depending on the type of instrument to be driven. In order in this case to simplify the handling by the dentist, there is provision that the corresponding adjustment possibilities or control options are displayed on the display 30 driven by the apparatus 20 as a component of the graphical user interface. In this respect, FIGS. 3 to 5 show in exemplary manner various representations on the display 30 and will be elucidated in the following.

Firstly, FIG. 3 shows a representation in which different functions can be called up from a main menu or various submenus can be called up. In this regard, in the left-hand region of the display a menu bar is represented which shows the symbols of various submenus which can be selected by the treating dentist. As a result of the selection of a corresponding submenu there is then, for example, the possibility of calling up programs for patient management and also for image management or image representation, in order to illustrate results of examination graphically for the patient.

On the right-hand side of the representation there is further located an information bar 42 in which the current status of the dental treatment station is displayed. In this case, in particular in a field 43 the current assignment of the foot-switch is also represented. In the exemplary embodiment that is represented, the foot-switch can accordingly be employed for the purpose of adjusting the patient chair, with the functionality of the individual push-buttons of the foot-switch being illustrated by graphical symbols. For the dentist it is accordingly immediately evident in simple manner how he/she can adjust the patient chair in desired manner solely by the actuation of the foot-switch.

It is to be noted that as a result of the selection of an appropriate treatment instrument at the dental treatment station 1 the functionality of the foot-switch is also changed. If, for example, a dental drill is removed from the instrument storage compartment 6, the control unit of the treatment station 1 detects automatically that the drilling handpiece is now to be driven with the aid of the foot-switch 15. In response to a corresponding communication of information by the treatment station 1 to the apparatus 20, the representation on the display 30 then also changes accordingly and changes, for example, to the representation according to FIG. 4. In this connection, on the one hand the operating parameters—here, in particular, the speed of rotation of the drill being used, the gear ratio of the transmission, the direction of rotation, light, spray etc.—are displayed with the aid of corresponding displays 44, 45. Furthermore, the altered assignment of the foot-operated push-buttons of the foot-switch 15 is also evident for the dentist via the field 43 which is now represented in enlarged manner. Once again, the operation for the dentist is simplified, since the latter can recognize in simple manner how the dental drill can be driven with the aid of the various push-buttons of the foot-switch 15.

Error conditions of the dental treatment station possibly occurring are also displayed on the display, in order to be able to detect possible errors and causes of errors more easily. If an error occurs (e.g. a safety shutdown of an instrument), a corresponding item of error information appears which, depending on the severity of the error, disappears after a certain time or remains visible until the error has been eliminated. In the course of a system start of the apparatus 20, warning messages and error conditions of the treatment station 1 are ascertained and are represented in a list where appropriate. For each warning and each error an item of information or instruction for elimination can then be called up.

The aforementioned monitoring of the dental treatment station furthermore also includes a check as to whether the appropriate instruments for treatment/examination are located at the correct positions. For example, via the status information obtained within the scope of the data communication it can be established whether the position of the detected instruments coincides with the desired position. Via a corresponding graphical display a prompt could then be given, where appropriate, for correction of the instrument position. Furthermore, the hygiene status of the instruments can also be monitored. The representation of error messages and error information of such a type may, of course, also be effected with regard to further instruments directly attached to the apparatus or registered at the apparatus, for example the intraoral camera.

In particularly preferred manner there is provision that the apparatus detects automatically—where appropriate in collaboration with the control unit of the treatment station—which instruments are attached—via cables or even in wireless manner—and available. Furthermore, the functionality of the push-buttons of the foot-switch and also the corresponding display on the display are adapted automatically upon removal or other preparatory commissioning of an instrument.

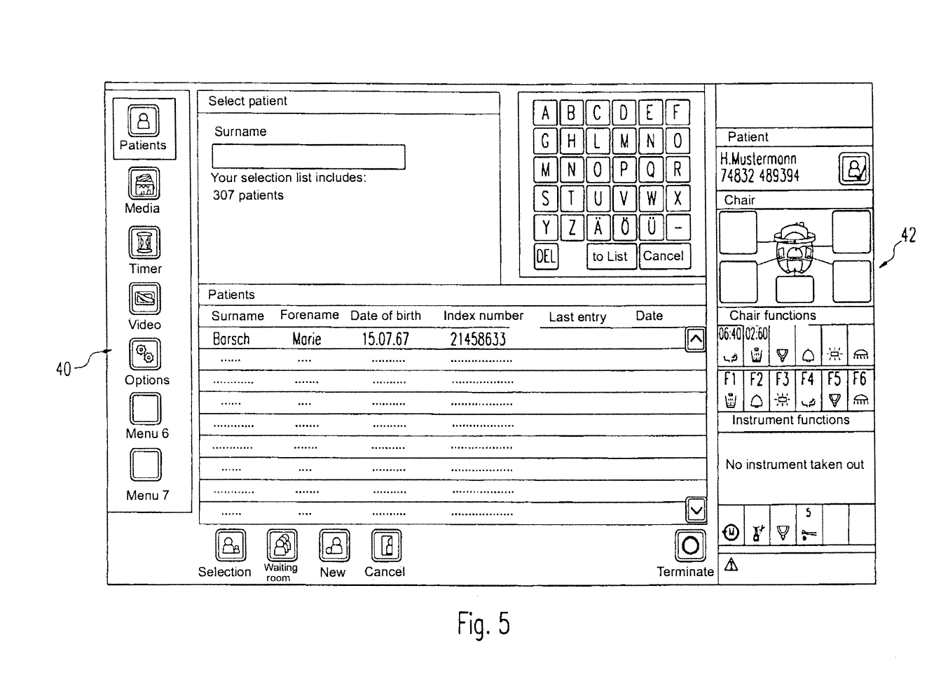

The graphical user interface of the apparatus 20 furthermore also enables the management of patient-related data, as the representation in FIG. 5 shows. In this case the graphical representation of a patient management is shown, via which the dentist can enter diagnostic results associated with the patient and can also store treatment information. In this case, once again an input can be effected by an appropriate assignment of the push-buttons of the foot-switch. Input with the aid of a supplementary keypad would also be useful for the input of text information.

Not represented, furthermore, is the option to represent information obtained by the intraoral camera or another imaging source on the display 30. For this purpose the apparatus 20 exhibits internally components that enable a processing of the image data obtained from the camera, whereby, alternatively or concurrently, up to five still images—which are generated by the actuation of the foot-switch 15—and live images can be represented. The integration of the camera images into the graphical user interface then opens up the possibility in straightforward manner to save corresponding image data in patient-related manner in a corresponding database of the dental surgery.

Lastly, the daily work of the dentist is assisted by the apparatus according to the invention, inasmuch as a graphical representation is given of how the treatment instruments and/or diagnostic instruments of a dental treatment station that are currently being used can be operated. The driving of the most diverse instruments with the aid of a central control element is simplified in this way, so that the dentist is able to concentrate primarily on handling the instruments. Furthermore, the management and archiving of the information obtained within the scope of the treatment or examination is supported, without the use of a separate PC or such like being required.

1. Apparatus for displaying and managing system parameters and data pertaining to a dental treatment station comprising:
a connector for connecting the apparatus to a display for displaying the system parameters and data, and
communication means for data exchange with the dental treatment station,
wherein
the communication means query data concerning the current operating state of the treatment station at regular time-intervals.

2. Apparatus according to claim 1,
wherein
the information about the operating state of the treatment station is represented on the display within the scope of a graphical user interface.

3. Apparatus according to claim 2,
wherein
said apparatus is capable of being connected to an external operating element for navigating by the graphical user interface.

4. Apparatus according to claim 3,
wherein
the external operating element comprises a foot-switch provided at the dental treatment station.

5. Apparatus according to claim 4,
wherein
functions that are currently capable of being selected by the foot-switch are represented on the display within the scope of the graphical user interface.

6. Apparatus according to claim 4,
wherein control information for navigating by the graphical user interface is communicated directly from the dental treatment station to the control unit by the foot-switch.

7. Apparatus according to
claim 1, wherein
said apparatus is capable of being connected to a communications network by additional communication means.

8. Apparatus according to claim 7,
wherein
the communication with the communications network includes both the transmission of acquired system parameters and data from the apparatus and the transmission of patient information and data to the apparatus.

9. Apparatus according to,
claim 1, wherein
said apparatus is capable of being connected to an image-recording unit.

10. Apparatus according to claim 9,
wherein
said apparatus comprises means for processing and representing the information communicated from the image-recording unit.

11. Arrangement comprising a dental treatment station and also an apparatus for displaying and managing system parameters and data pertaining to the dental treatment station according to claim 1.

12. Apparatus according to claim 7, wherein said communications network is a surgery network.

13. Apparatus according to claim 9, wherein said image-recording unit is a camera.
